(19) United States
(12) Patent Application Publication
(10) Pub. No.: US 2004/0047527 A1
(43) Pub. Date: Mar. 11, 2004

(54) Bicycle bearing journal assembly

(76) Inventor: Cheng-Xun Jiang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/237,959

(22) Filed: Sep. 10, 2002

(51) Int. Cl. F16C 13/00

(52) U.S. Cl. 384/545

(57) ABSTRACT

A combination of a bearing journal assembly and a head tube of a bicycle includes a skirt extending from each of two ends of the head tube and each skirt has a groove defined therein. A retainer has a plurality of balls rotatably engaged therewith as a one-piece member which is engaged with the groove in each skirt.

### FIELD OF THE INVENTION

The present invention relates to a bicycle bearing journal assembly that includes a skirt portion on an end of the head tube of the bicycle and steel balls and a top race are engaged with the skirt portion.

### BACKGROUND OF THE INVENTION

A conventional bearing journal assembly for bicycles is shown in FIG. 4 and generally includes a lower race 10 having a groove defined in a top thereof and a plurality of steel balls 11 are arranged in the groove and a retainer 20 is mounted to the balls 11 and retains the balls 11. A top race 30 is mounted to the lower race 10 so as to position the retainer 20. The conventional way requires precise skill to position the steel balls 11 one by one and takes a lot of time to assemble a bearing journal assembly. The bearing journal assembly is then engaged with each of two ends of the head tube so that a steering tube may extend through the bearing journal assemblies so that the steering tube can smoothly rotate.

The present invention intends to provide a bearing journal assembly for bicycles and the bearing journal assembly includes a skirt portion extending directly from each of the two ends. The balls are combined with a retainer as a one piece which is engaged with the skirt portion.

### SUMMARY OF THE INVENTION

In accordance with one aspect of the present invention, there is provided a combination of a bearing journal assembly and a head tube, and the combination comprises a skirt extending from each of two ends of the head tube and having a groove defined therein. A plurality of balls are rotatably engaged with a retainer as a one-piece member which is engaged with the groove in each skirt.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a head tube with two bearing journal assemblies and a head tube;

FIG. 2 includes two cross sectional views of the combination of the bearing journal assembly and the head tube;

FIG. 3 is a perspective view to show a steering tube extending through the head tube of the bearing journal assembly and the head tube, and

FIG. 4 is an exploded view to show a conventional bearing journal assembly.

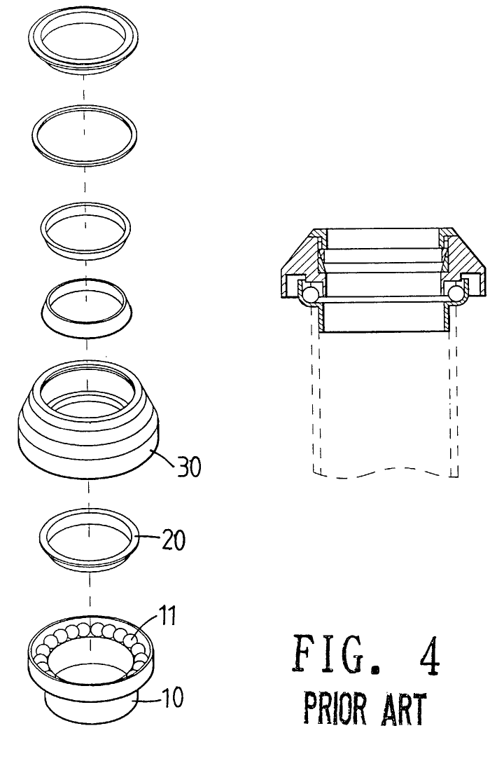

### DETAILED DESCRIPTION OF THE PREFERRED EMBODIMENT

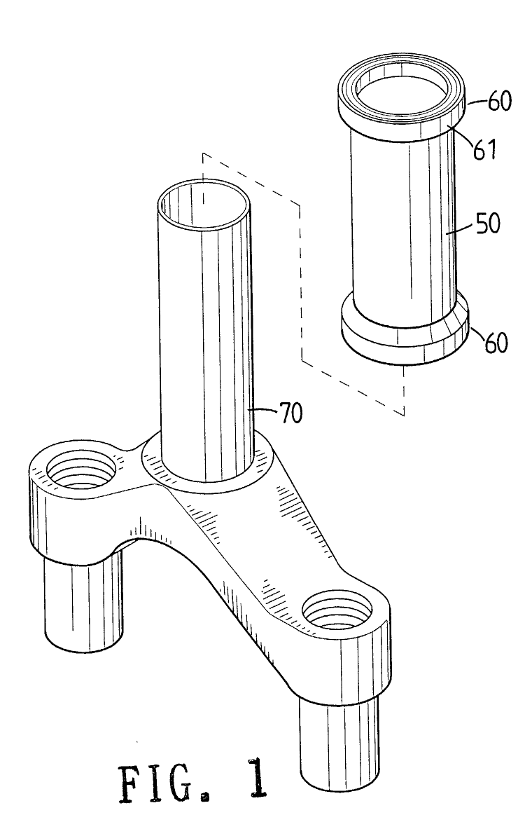

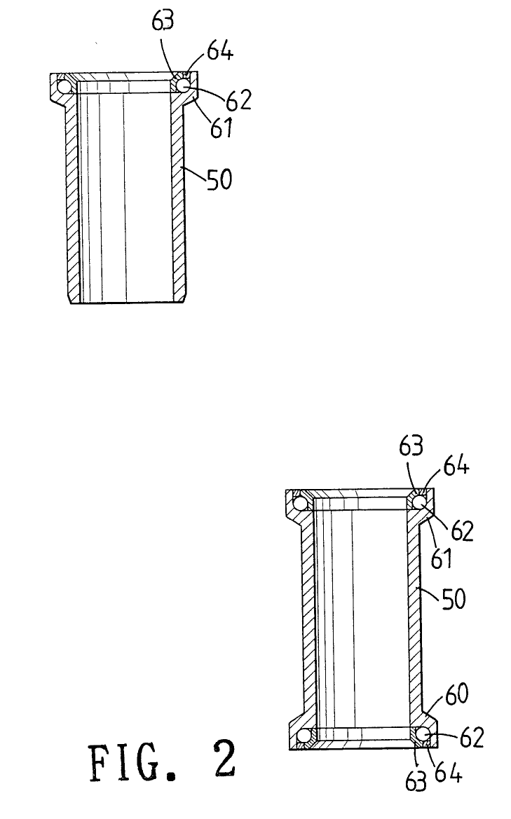

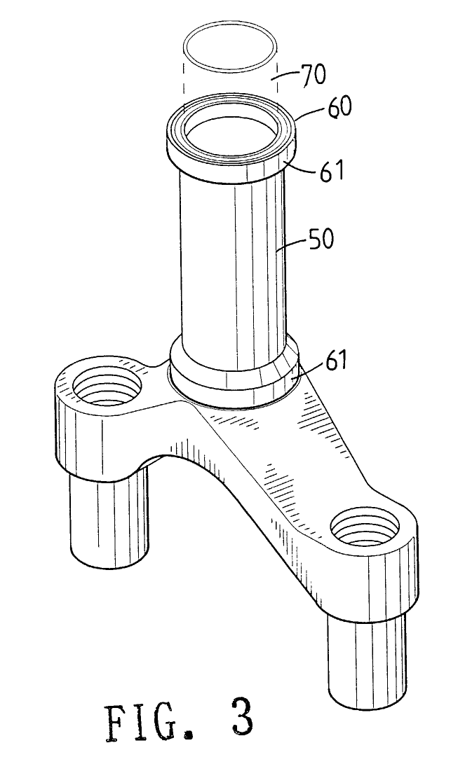

Referring to FIGS. 1 to 3, the combination of the bearing journal assembly 60 and the head tube 50 of the present invention comprises a skirt 61 extending from each of two ends of the head tube 50 and each skirt 61 has a groove defined therein.

A plurality of balls 62 are rotatably engaged with a retainer 63 as a one-piece member which is engaged with the groove in each skirt 61. The balls 62 may also be arranged in the retainer 63 by manual way. A seal cap 64 is further located between the balls 62 and the retainer 63 so as to prevent rain or dust entering the space between the balls 62 and the retainer 63. A steering tube 70 extends through the head tube 50 and the two bearing journal assemblies 60 are mounted to the steering tube 70 which is then smoothly rotated relative to the head tube 50.

The bearing journal assembly 60 is combined with the skirt 61 extending from each of the two ends of the head tube 50 directly so that the assembling time can be reduced and the precision of the assembly can be increased.

While we have shown and described the embodiment in accordance with the present invention, it should be clear to those skilled in the art that further embodiments may be made without departing from the scope of the present invention.

What is claimed is:

1. A combination of a bearing journal assembly and a head tube, the combination comprising:
a skirt extending from each of two ends of the head tube and having a groove defined therein, and
a retainer and a plurality of balls rotatably engaged with the retainer as a one-piece member which is engaged with the groove in each skirt.

2. The assembly as claimed in claim 1 further comprising a seal cap located between the balls and the retainer.
